(19) United States
(12) Patent Application Publication
(10) Pub. No.: US 2021/0010850 A1
(43) Pub. Date: Jan. 14, 2021

(54) FEED PLATE AND BEAM STABILIZER FOR A GRANULAR MATERIAL WEIGHING SYSTEM

(71) Applicant: BRAND D. COLE, MACOMB, OK (US)

(72) Inventor: BRAND D. COLE, MACOMB, OK (US)

(21) Appl. No.: 16/920,400

(22) Filed: Jul. 2, 2020

Related U.S. Application Data
(60) Provisional application No. 62/872,185, filed on Jul. 9, 2019.

(51) Int. Cl. G01G 13/06; G01G 13/00

(52) U.S. Cl. CPC G01G 13/06; G01G 13/003

(57) ABSTRACT

The feed plate and beam stabilizer for a granular material weighing system are components used with granular material weighing systems, such as those used for filling cartridges with gunpowder. The feed plate is a circular plate disposed within a hopper of a granular material trickler. The circular plate is spaced apart from the bottom of the hopper by a plurality of substantially L-shaped members, which are used to impart movement to granular material contained in the granular material trickler when the circular plate is driven to rotate. The beam stabilizer includes a stabilizing wire connected to a lever arm for selectively contacting a beam of a beam balance of a granular material weighing system. The stabilizing wire makes contact with the beam to provide additional dampening to the beam to cease oscillation thereof following discharge of granular material into the weighing pan of the granular material weighing system.

### CROSS-REFERENCE TO RELATED APPLICATION

This application claims the benefit of U.S. Provisional Patent Application No. 62/872,185, filed on Jul. 9, 2019.

### BACKGROUND

### 1. Field

The disclosure of the present patent application relates to weighing and metering systems, and particularly to a feed plate and beam stabilizer for a granular material weighing system.

### 2. Description of the Related Art

FIG. 2 illustrates a conventional prior art granular material weighing system of the type described in U.S. Pat. No. 6,121,556, issued Sep. 19, 2000 to the present inventor, which is hereby incorporated by reference in its entirety. The granular material weighing system 100 of FIG. 2 includes a scale in the form of a beam balance 102, having a weighing pan 106. The weighing pan 106 has a hole 120 formed through its bottom, which is selectively covered and sealed by a plug 114. Plug 114 is shown connected to a string 122, the plug 114 being used to selectively contain or dispense a granular material held in the weighing pan 106.

The beam balance 102 includes a beam 108 and a sliding weight poise 110, which is adjustably mounted thereon. The beam 108 is balanced across a stand 112. The weighing pan 106 is mounted on one end of the beam 108, and the other end of beam 108 may be damped by a damping device 104. In the example of FIG. 2, the damping device 104 is shown as a conventional magnetic damper, where resistance is created when an electrically conductive substance, such as copper, moves through a magnetic field. A pointer 128 lines up with a balance indicator 130 when the beam 108 is balanced. A copper plate 129 extends from the end of the beam 108. Magnets 132 are positioned above and below the balance indicator 130 on either side of the beam 108. As the beam 108 oscillates, the copper plate 129 is moved through the magnetic field created by magnets 132, damping the beam's oscillations.

A translating bar 154 is located below a powder hopper 152, which contains the powder P to be dispensed. Attached within one end of the translating bar 154 is a sliding insert 156. A volumetric container 158 is defined between the translating bar 154 and the sliding insert 156. A threaded bolt 160 attaches the sliding insert 156 to the translating bar 154, and by turning the bolt 160, the insert 156 slides to either expand or shrink the volumetric container 158. Powder chute 162 is below the translating bar 154 and terminates above the weighing pan 106. A housing 164 surrounds the translating bar 154, and the T-handle 166, attached to the translating bar 154 opposite the bolt 160, is used to actuate the translating bar 154.

In use, the bolt 160 is first turned to slide insert 156, thereby setting the volumetric container 158 to the appropriate size. The handle 166 is pulled outward, sliding the volumetric container 158 under the powder hopper 152. Powder P falls into the volumetric container 158, and is contained between the translating bar 154, the insert 156, and the housing 164. The handle 166 is then pushed inward, moving the volumetric container 158 over the powder chute 162, allowing the powder P to then fall down the powder chute 162 and into the weighing pan 106. As shown, a string 122 may connect directly to the translating bar 154. Thus, as the translating bar 154 is pulled outward, moving the volumetric container 158 under the hopper 152, the plug 114 is lifted from the hole 120. As the translating bar 154 is pushed inward, moving the volumetric container 158 over the powder chute 162, the plug 114 is lowered to seat into the hole 120.

FIG. 2 illustrates the exemplary granular material weighing system being used to dispense gunpowder, specifically, dispensing a weighed gunpowder charge from the weighing pan 106 into a cartridge case 190 positioned beneath a funnel 192. Each filling/dispensing cycle, except the first cycle, begins with a weighed powder charge in the weighing pan 106 and a cartridge case 190 positioned under the funnel 192. The volumetric container 158 will be set to measure a powder charge close to, but less than, the final desired weight by moving the insert 156 to the appropriate position using the bolt 160, and the weight poise 110 will be positioned on the beam 108 at the location corresponding to the desired final weight. In the system of FIG. 2, a conventional trickler 180 or similar device (referred to as a “dribbler” in the '556 patent) is used to feed additional powder P from a hopper 182 into the weighing pan 106 until the beam 108 is balanced. The operation of the trickler 180 will be described in greater detail below. Tricklers are commonly used dispensers for dispensing or feeding single pieces, parts or grains, or at least relatively small quantities of such.

When the volumetric charge is dispensed into the weighing pan 106 from the volumetric container 158, the impact within the pan 106 causes the beam 108 to oscillate. Even with the damper described above, it can take a few seconds for the beam 108 to cease oscillating. In an automated system, the cessation of the beam's movement is registered by, for example, an optical system, which also reads the beam's position for automated activation of the trickler 180 to top off the charge. It has occurred to the present inventor that if the beam 108 can be stabilized while the charge is impacting the weighing pan 106 during dispensing in order to reduce oscillation of the beam 108, overall cycle time of the system 100 may also be reduced.

The trickler 180 of FIG. 2 includes the powder hopper 182, a feed mechanism 184, and a feed barrel 186, which may either be a rotary barrel with internal threads or a vibrating barrel. As shown in FIG. 4, the feed mechanism 184 may include a rotating feed plate 202a, which is driven to rotate by axle 188 of motor 170. FIG. 3A shows a conventional rotating feed plate 202a, which has a plurality of circumferential holes 204a formed therein. FIG. 3B shows an alternative conventional rotating feed plate 202b, which has a plurality of circumferential recesses or slots 204b formed therein. As shown in FIG. 4, when one of the holes 204a of rotating feed plate 202a (or recesses 204b of rotating feed plate 202b) aligns with an opening 172 formed through the bottom 174 of the hopper 182, the additional powder P is free to fall from the hopper 182 to be dispensed by the feed barrel 186 in a metered manner.

Gunpowder is not necessarily provided in purely uniform granular form. It can be provided in a substantially cylindrical shape, with varying uniformity. When used with a feed plate, such as rotating feed plate 202a, the cylindrical pieces or parts fall through the holes 204a, with the cylindrical part standing vertically. When used with a slotted feed plate, such as rotating feed plate 202b, the cylindrical pieces or parts fall sideways through the slots or recesses 204b. The parts contained within the hopper 182 ride on the rotating feed plate 202a (or 202b) until they fall through the holes 204a (or slots 204b). In practice, in order to operate smoothly and precisely, the gunpowder pieces need to be relatively uniform, and the holes 204a or slots 204b must be carefully sized to match the parts. The cylindrical pieces are often formed through an extrusion process, and long extruded pieces are then cut to obtain short cylindrical parts. This cutting can result in relatively non-uniform lengths, including breakage of the materials, resulting in further non-uniformities and obliquely angled ends. The prior art “top riding” rotating feed plates cannot easily accommodate these non-uniform parts, while still operating effectively and precisely.

Thus, a feed plate and beam stabilizer for a granular material weighing system solving the aforementioned problems is desired.

### SUMMARY

The feed plate for a granular material weighing system is a rotating feed plate for use with a trickler (or similar device) of the granular material weighing system. As would be recognized by one of ordinary skill in the art, the term “trickler”, as used herein, refers to a feeding device for gradually adding granular parts or pieces to bring a sample up to the precise desired weight, and typically includes a rotating feed plate placed within a flat-bottomed receptacle. The feed plate includes a circular plate having opposed upper and lower surfaces, and further having a central annular hub, which may be adapted for mounting to a rotating shaft of the granular material trickler. The circular plate has a plurality of slots formed therethrough. A plurality of substantially L-shaped members extend downward from the lower surface of the circular plate. The circular plate may be adapted to be received within a hopper of the granular material trickler and to be rotatably mounted near the bottom of the hopper. The circular plate is spaced apart from the bottom of the hopper by the plurality of substantially L-shaped members. Thus, in contrast to a conventional rotating feed plate for tricklers, in which granular material contained within the hopper “rides” on the top surface of the feed plate as it rotates until falling through a slot for dispensing, the present feed plate allows the granular material to initially fall through the slots to be contained between the circular plate and the bottom of the hopper. The plurality of substantially L-shaped members then impart the rotating movement of the granular material for dispensing thereof.

The beam stabilizer for the granular material weighing system provides a gentle stabilizing force to the beam of the beam balance in order to provide additional dampening to cease the oscillatory movement of the beam when a volumetric charge is dispensed into the weighing pan from the volumetric container. The beam stabilizer may be in the form of a lever arm having opposed first and second ends, with a first end of a stabilizing wire being adapted for selectively contacting and stabilizing the beam of the beam balance, and a second end thereof being mounted on the first end of the lever arm. An actuating rod selectively applies a downward force to the second end of the lever arm.

In order to better govern the movement and control of the stabilizing wire, the lever arm may be a dual-arm lever, including first and second pivoting arms mounted on a single common vertical support. A lower end of the vertical support is mounted on a support surface, such as the stand of the beam balance. A central portion of the first pivoting arm is pivotally secured to the upper end of the vertical support. Upper and lower pins project from the first end of the first pivoting arm.

A second end of the stabilizing wire is mounted on a first end of the second pivoting arm, such that the stabilizing wire extends between the upper and lower pins of the first pivoting arm. A second end of the second pivoting arm is pivotally secured to the upper end of the vertical support, and pivots freely and separately from the first pivoting arm.

The actuating rod selectively applies the downward force to the second end of the first pivoting arm such that the downward force causes the first end of the first pivoting arm to rotate upward about the upper end of the vertical support. The upward rotation of the first end of the first pivoting arm brings the lower pin into contact with the stabilizing wire to lift the stabilizing wire out of contact with the beam of the beam balance. Removal of the actuating rod from the second end of the first pivoting arm causes the first end of the first pivoting arm to rotate downward about the upper end of the vertical support under its own weight. The downward rotation of the first end of the first pivoting arm brings the upper pin into contact with the stabilizing wire to drop the stabilizing wire to contact the beam of the beam balance.

These and other features of the present disclosure will become readily apparent upon further review of the following specification and drawings

### BRIEF DESCRIPTION OF THE DRAWINGS

FIG. 1A is a bottom perspective view of a feed plate for a granular material weighing system.

FIG. 1B is a top perspective view of the feed plate of FIG. 1A.

FIG. 2 is a perspective view of a prior art granular material weighing system.

FIG. 3A is a top view of a prior art feed plate for use with the granular material weighing system of FIG. 2.

FIG. 3B is a top view of an alternative embodiment of a prior art feed plate for use with the granular material weighing system of FIG. 2.

FIG. 4 is a partial side view in section of a prior art trickler for use with the granular material weighing system of FIG. 2.

FIG. 5 is a partial environmental side view in section of the feed plate of FIGS. 1A and 1B installed in a trickler of a granular material weighing system, the optional prongs being omitted from the feed plate.

FIG. 6 is an environmental perspective view of a beam stabilizer for a granular material weighing system, shown with an actuating rod moving downward to contact one end of a lever arm.

FIG. 7 is an environmental perspective view of the beam stabilizer of FIG. 6, shown with the actuating rod contacting and imparting a downward force to one end of the lever arm.

FIG. 8 is an environmental perspective view of the beam stabilizer of FIG. 6, shown with the actuating rod continuing to contact and impart downward force to one end of the lever arm.

FIG. 9 is an environmental perspective view of the beam stabilizer of FIG. 6, shown with the actuating rod moving upward and out of contact with the lever arm.

Similar reference characters denote corresponding features consistently throughout the attached drawings.

### DETAILED DESCRIPTION OF THE PREFERRED EMBODIMENTS

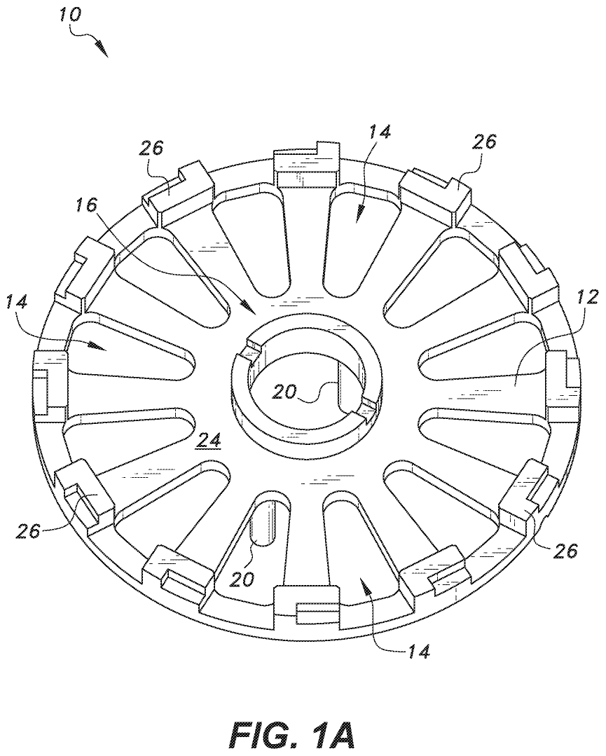

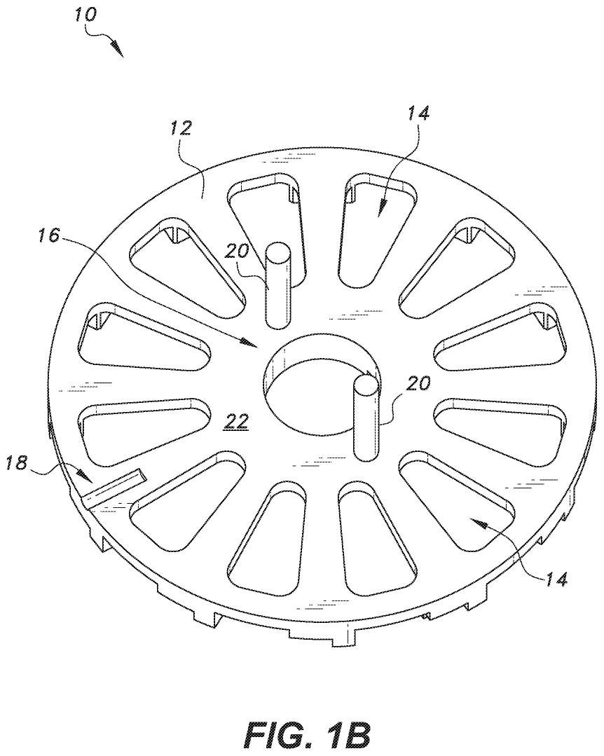

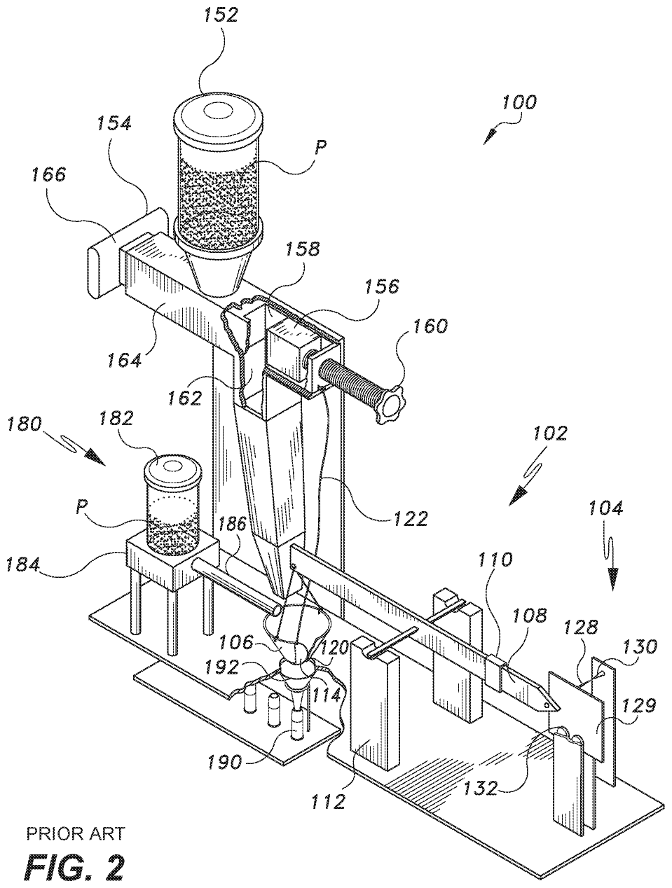

Referring now to FIGS. 1A and 1B, the feed plate for a granular material weighing system, designated generally as 10 in the drawings, is a rotating feed plate for use with a trickier of the granular material weighing system. For example, the feed plate 10 may be used with the trickier 180 of FIG. 2, although it should be understood that the term “trickier”, as used herein, refers to a device that gradually feeds granular parts or pieces onto a scale to bring the mass of a volumetric sample up to the precise targeted mass, the trickier typically including a rotating feed plate placed near the bottom of the trickler's hopper.

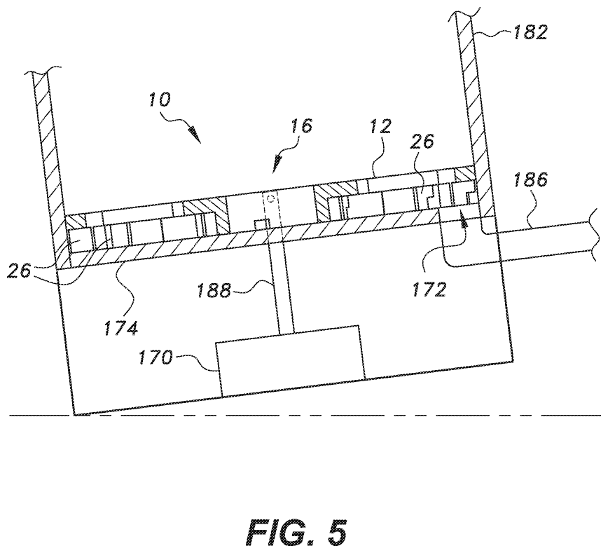

The feed plate for a granular material weighing system 10 includes a circular plate 12 having opposed upper and lower surfaces 22, 24, respectively, and further having a central annular hub 16 adapted for mounting to a rotating shaft of the granular material trickier. FIG. 5 illustrates the feed plate 10 mounted within the hopper 182 of the trickier 180, although it should be understood that the feed plate 10 may be used with any suitable type of trickier or similar feeding or dispensing device. As shown, the feed plate 10 is mounted on the shaft 188 of a motor 170 through interconnection the shaft 188 with the central annular hub 16.

The circular plate 12 has a plurality of slots 14 formed therein. It should be understood that the number, shape and relative dimensions of slots 14 are shown in FIGS. 1A and 1B for exemplary purposes only. Further, as shown in FIG. 1B, optionally a pair of prongs 20 may project axially from the upper surface 22 of circular plate 12. Similar to a conventional rotating feed plate, the prongs 20 provide a gripping surface for connection and adjustment of the feed plate 10, as well as providing mixing and distributing functions for granular material received on the upper surface 22 of the circular plate 12 (prior to the granular material falling through the slots 14). Additionally, texturing may be added to the upper surface 22 to urge movement of the granular material such that it falls through the slots 14. A radially extending groove 18 may be formed in the upper surface 22, although it should be understood that any suitable type of texturing may be used.

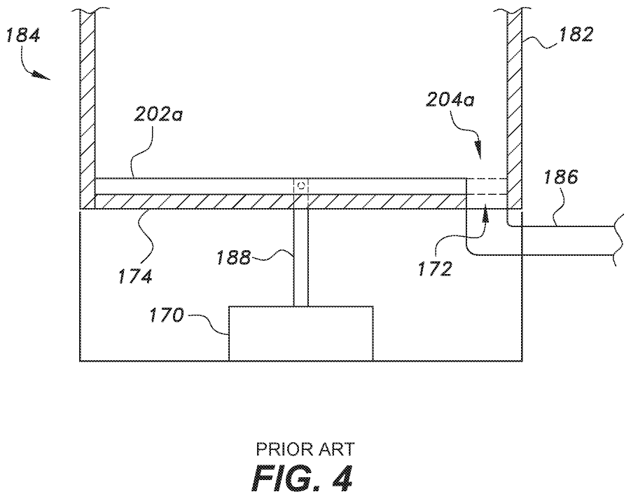

As shown in FIG. 1A, a plurality of substantially L-shaped members 26 depend from the lower surface 24 of the circular plate 12. As shown in FIG. 5, the circular plate 12 is disposed within the hopper 182 of the granular material trickler and is rotatably mounted near the bottom 174 of the hopper 182. The circular plate 12 is spaced apart from the bottom 174 of the hopper 182 by the plurality of substantially L-shaped members 26. Thus, in contrast to a conventional rotating feed plate for tricklers, such as the feed plate 202a shown in FIG. 4, in which granular material contained within the hopper 182 “rides” on the top surface of the feed plate 202a until falling through slots 204a and 172 for dispensing, the feed plate 10 allows the granular material to initially fall through the slots 14 to be contained between the circular plate 12 and the bottom 174 of the hopper 182. As shown in FIG. 5, the hopper 182 may be angled with respect to the horizontal, allowing the plurality of substantially L-shaped members 26 to impart rotating movement to the granular material for dispensing thereof by carrying the granular material to the opening 172 in the bottom 174 of the hopper 182. By containing the granular material between the circular plate 12 and the bottom 174 of the hopper 182 after the granular material falls through the relatively wide slots 14, the feed plate 10 allows for the effective dispensing of granular material that is not necessarily uniform and regularly shaped.

Although the feed plate 10 has been described in particular detail for use with a granular weighing system, and especially for use in a trickler of a weighing system that starts with a volumetric sample that is intentionally less than the final desired mass so that the trickier gradually adds additional material to bring the final mass up to the target mass, it will be understood that the feed plate 10 may be used in other applications in manufacturing or automated processing equipment having a hopper with a rotating feed plate for adding additional powder or granulated material during operation. An example of such an application may be in the plastics industry, where an initial volume of plastic resin may be added to an extruder or injection molding machine and a hopper with a rotating feed plate may be used to add additional resin to bring the quantity of resin up to the precise level needed for extrusion or molding of a plastic part to specification. Other applications will be readily apparent to those of ordinary skill in the manufacturing arts.

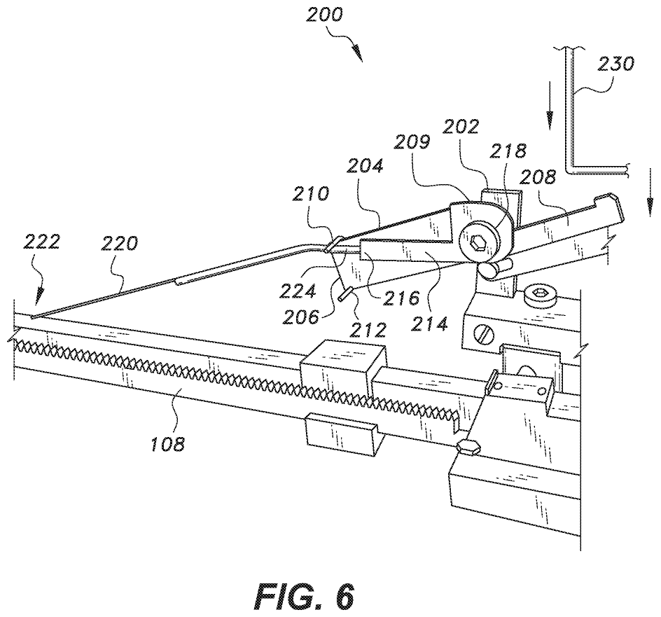

As shown in FIGS. 6-9, the beam stabilizer for the granular material weighing system 200 provides a gentle stabilizing force to the beam of a beam balance, such as beam 108 of beam balance 102 of the granular material weighing system 100 of FIG. 2. However, it should be understood that the beam stabilizer 200 may be used in combination with any suitable type of beam balance to provide additional dampening. In the example of beam balance 102 of the granular material weighing system 100 of FIG. 2, this additional dampening is used to cease the oscillatory movement of beam 108 when a volumetric charge is dispensed into the weighing pan 106 from volumetric container 158.

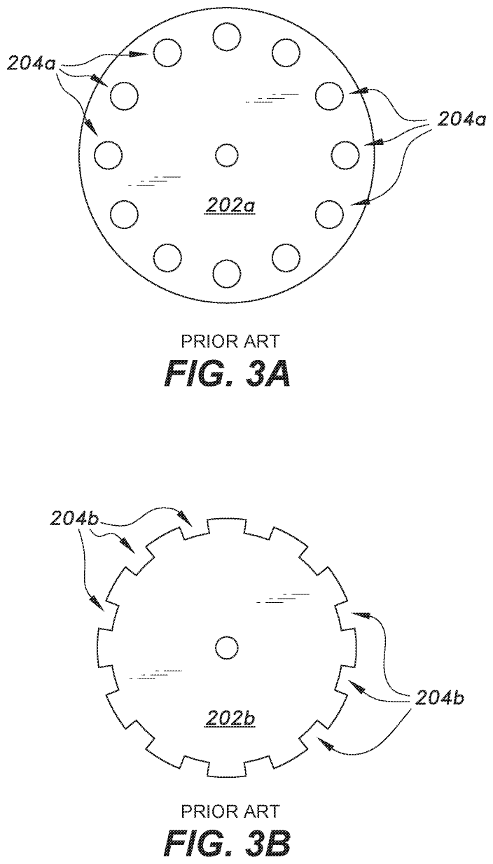

The beam stabilizer 200 may be in the form of a lever arm having opposed first and second ends. The first end 222 of a stabilizing wire 220 is adapted for selectively contacting and stabilizing the beam 108 of beam balance 102. The second end 224 of the stabilizing wire 220 is mounted on the first end of the lever arm. An actuating rod 230 selectively applies a downward force to the second end of the lever arm. In the example of the granular material weighing system 100, the upper end of the actuating rod 230 may be rotatably attached to rotary drum 106 of FIG. 3 of U.S. Pat. No. 6,121,556, cited above, such that when the volumetric charge is dispensed into the weighing pan 106 from volumetric container 158, the actuating rod 230 is in its raised position, as shown in FIG. 6.

As shown in FIGS. 6-9, in order to better govern the movement and control of the stabilizing wire 220, the lever arm may be a dual-arm lever, including first and second pivoting arms 204, 214, respectively, mounted on a common axle on a single common vertical support 202. A lower end of the vertical support 202 is mounted on a support surface, such as the stand 112 of the beam balance 102. A central portion 209 of the first pivoting arm 204 is pivotally attached to the upper end of the vertical support 202. Upper and lower pins 210, 212 project from a first end 206 of the first pivoting arm 204.

A second end 224 of the stabilizing wire 220 is mounted on a first end 216 of the second pivoting arm 214 such that the stabilizing wire 220 extends between the upper and lower pins 210, 212 of the first pivoting arm 204. A second end 218 of the second pivoting arm 214 is pivotally attached to the upper end of the vertical support 202 and pivots freely and independently of the first pivoting arm 204.

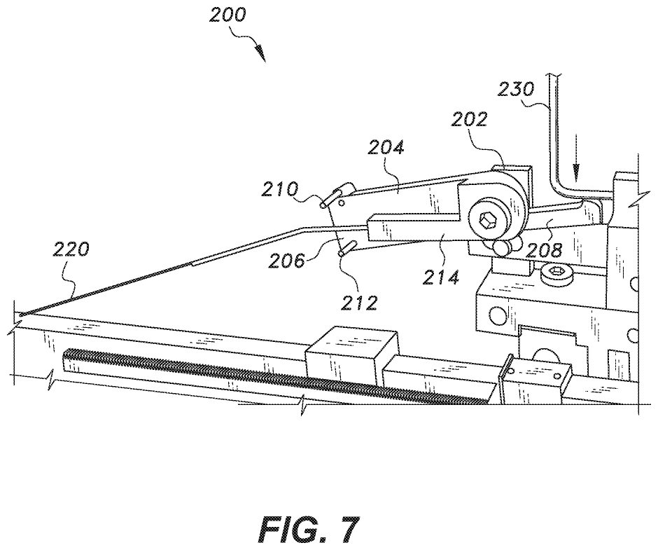

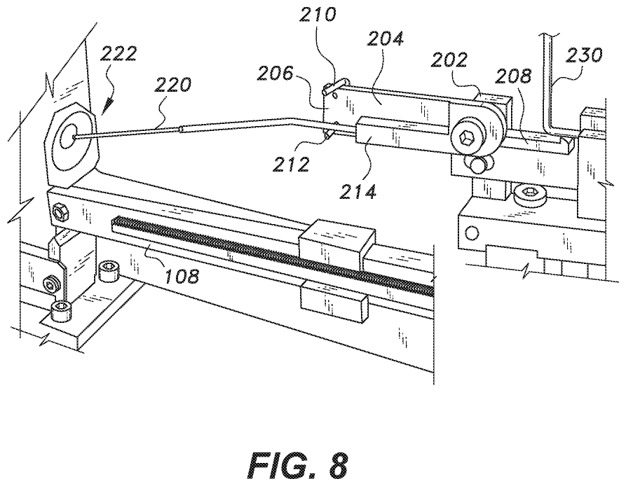

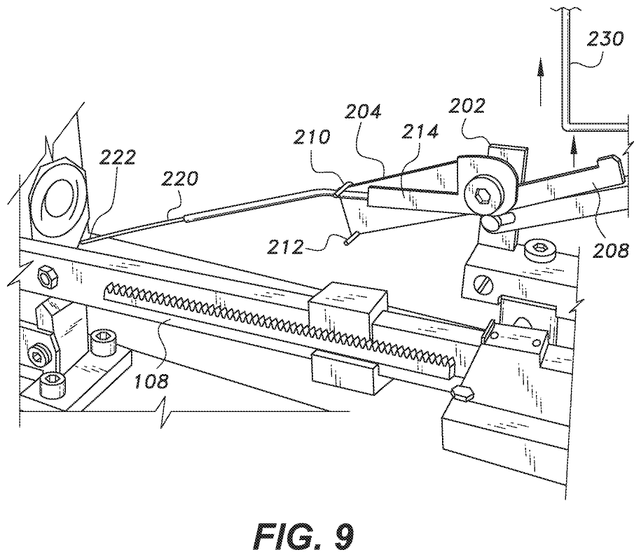

In FIG. 6, an actuating rod 230 is shown moving downward towards the second end 208 of the first pivoting arm 204. In FIG. 7, the actuating rod 230 contacts the second end 208, selectively applying a downward force to the second end 208 of the first pivoting arm 204. This clockwise torque (in the orientation of FIG. 7) causes the first end 206 of the first pivoting arm 204 to rotate upward about the upper end of the vertical support 202. The upward rotation of the first end 206 of the first pivoting arm 204 brings the lower pin 212 into contact with the stabilizing wire 220 to lift the stabilizing wire 220 out of contact with the beam 108, as shown in FIG. 8. As shown in FIG. 9, removal of the actuating rod 230 from the second end 208 of first pivoting arm 204 causes the first end 206 of the first pivoting arm 204 to rotate downward about the upper end of the vertical support 202 under its own weight, i.e., under the force of gravity, the first pivoting arm 204 begins to rotate counterclockwise (in the orientation of FIG. 9). The downward rotation of the first end 206 of first pivoting arm 204 brings the upper pin 210 into contact with the stabilizing wire 220 to drop the stabilizing wire 220 to contact the beam 108 to provide the stabilizing damping force thereto.

In practice, during automatic operation, photocells directed at the weighing pan 106 or the beam 108 control activation of the trickler 180. When the volumetric charge is dispensed onto the weighing pan, the beam 108 tends to oscillate briefly due to the weight falling on the pan. When the beam stops oscillating, the photocell(s) can read its position and determine that the volumetric charge is less than the targeted charge mass. The signal from the photocell then adds additional charge to bring the mass on the weighing pan up to the targeted charge mass. The purpose of the stabilizer is to hold down the back end of the beam briefly (perhaps a second) as the volumetric charge hits the weighing pan so that the photocell can read the beam's position and activate the trickler to dispense more charge without waiting for the oscillations to stabilize. Hence, the weighing cycle per cartridge becomes somewhat faster and more efficient. The actuating rod 230 is connected to the volumetric charge mechanism such that the stabilizer wire holds down the back end of the beam when the volumetric charge is dispensed and is lifted off the beam when a new volumetric charge is to be dispensed.

It is to be understood that the feed plate and beam stabilizer for a granular material weighing system is not limited to the specific embodiments described above, but encompasses any and all embodiments within the scope of the generic language of the following claims enabled by the embodiments described herein, or otherwise shown in the drawings or described above in terms sufficient to enable one of ordinary skill in the art to make and use the claimed subject matter.

We claim:

1. A beam stabilizer for a beam balance, comprising:
a vertical support having opposed upper and lower ends, the lower end being adapted for mounting on a support surface;
a lever having at least one pivoting arm having opposed first and second ends and a central portion pivotally attached to the upper end of the vertical support;
a stabilizing wire having opposed first and second ends, the first end being adapted for selectively contacting and stabilizing a beam of a beam balance, the second end extending from the first end of the at least one pivoting arm; and
an actuating rod selectively applying a downward force to the second end of the at least one pivoting arm;
wherein the downward force applied by the actuating rod on the second end of the at least one pivoting arm raises the stabilizing wire so that the beam is free to pivot and removal of the downward force applied by the actuating rod permits the stabilizing rod to fall against the beam by gravity, thereby dampening oscillations.

2. The beam stabilizer according to claim 1, wherein said lever comprises a dual-arm lever, said at least one pivoting arm including:
a first pivoting arm having opposed first and second ends and a central portion pivotally attached to the upper end of the vertical support, the downward force applied by the actuating rod being selectively applied to the second end of the first pivoting arm;
upper and lower pins projecting laterally from the first end of the first pivoting arm; and
a second pivoting arm having opposed first and second ends, the second end of the second pivoting arm being pivotally attached to the upper end of the vertical support, the second end of said stabilizer wire extending from the first end of the second pivoting arm, the stabilizing wire extending between the upper and lower pins of the first pivoting arm;
wherein the downward force applied by the actuating rod on the second end of the first pivoting arm rotates the first end of the first pivoting arm upward about the upper end of the vertical support so that the lower pin bears against and lifts the stabilizing wire out of contact with the beam of the beam balance, and removal of the actuating rod from the second end of the first pivoting arm rotates the first end of the first pivoting arm downward under its own weight so that the upper pin bears against the stabilizing wire and drops the stabilizing wire into contact with the beam of the beam balance to dampen oscillation of the beam.

3. The beam stabilizer as recited in claim 2, wherein the beam balance is incorporated into a volumetric weighing system, said actuating rod being synchronized with a volumetric dispensing system feeding volumetric charges onto the beam balance.

4. A granular material weighing system, comprising:
a beam balance having a beam, a damping mechanism, and a weighing pan, the weighing pan having means for selectively containing and selectively dispensing a granular material;
a volumetric measure having a hopper, an outlet and an actuating member, the actuating member selectively transferring the granular material from the hopper to the outlet and discharging the granular material onto the weighing pan of the beam balance;
a granular material trickler for selectively dispensing an auxiliary volume of the granular material into the weighing pan, the granular material trickler having:
an auxiliary hopper having a bottom and an opening defined in the bottom;
a rotating feed plate disposed in the auxiliary hopper and rotatably mounted above the bottom of the auxiliary hopper, the rotating feed plate being a circular plate defining a periphery and having opposed upper and lower surfaces and a central annular hub, the circular plate further having a plurality of slots defined therein, the rotating feed plate having a plurality of substantially L-shaped members depending from the periphery of the circular plate, the circular plate being spaced apart from the bottom of the auxiliary hopper by the plurality of substantially L-shaped members; and
a feed barrel having opposed first and second ends, the first end being in open communication with the opening defined in the bottom of the auxiliary hopper, the second end being adapted for dispensing the auxiliary volume of the granular material into the weighing pan; and
a beam stabilizer including:
a lever having at least one pivoting arm having opposed first and second ends;
a stabilizing wire having opposed first and second ends, the first end of the stabilizing wire being adapted for selectively contacting and stabilizing the beam of the beam balance, the second end extending from the first end of the at least one pivoting arm; and
an actuating rod selectively applying a downward force to the second end of the at least one pivoting arm.

5. The granular material weighing system as recited in claim 4, wherein said lever comprises a dual-arm lever, the beam stabilizer including a vertical support having an upper end, the at least one pivoting arm including:
a first pivoting arm having a first end, an opposing second end, a central portion pivotally attached to the upper end of the vertical support, and upper and lower pins projecting laterally from the first end of the first pivoting arm, the downward force applied by the actuating rod being selectively applied to the second end of the first pivoting arm; and
a second pivoting arm having a first end and an opposing second end, the second end of the second pivoting arm being pivotally attached to the upper end of the vertical support, the second end of the stabilizing wire extending from the first end of the second pivoting arm, the stabilizing wire extending between the upper and lower pins of the first pivoting arm;
wherein the downward force applied by the actuating rod on the second end of the first pivoting arm rotates the first end of the first pivoting arm upward about the upper end of the vertical support so that the lower pin bears against and lifts the stabilizing wire out of contact with the beam of the beam balance, and removal of the actuating rod from the second end of the first pivoting arm rotates the first end of the first pivoting arm downward under its own weight so that the upper pin bears against the stabilizing wire and drops the stabilizing wire into contact with the beam of the beam balance to dampen oscillation of the beam.

6. The granular material weighing system as recited in claim 5, wherein the rotating feed plate has a plurality of substantially L-shaped members depending from the periphery of the circular plate, the circular plate being spaced apart from the bottom of the auxiliary hopper by the plurality of substantially L-shaped members.

7. The granular material weighing system as recited in claim 6, wherein the feed plate further comprises:
a pair of prongs projecting axially from the upper surface of the circular plate; and
a radially extending groove formed in the upper surface of the circular plate.

8. The granular material weighing system as recited in claim 4, wherein the rotating feed plate has a plurality of substantially L-shaped members depending from the periphery of the circular plate, the circular plate being spaced apart from the bottom of the auxiliary hopper by the plurality of substantially L-shaped members.

9. The granular material weighing system as recited in claim 8, wherein the feed plate further comprises a pair of prongs projecting axially from the upper surface of the circular plate.

10. The granular material weighing system as recited in claim 9, wherein the upper surface of the circular plate of the feed plate includes texturing thereon.

11. The granular material weighing system as recited in claim 10, wherein the texturing comprises a radially extending groove formed in the upper surface of the circular plate.

12. A feed plate, comprising:
a circular plate having opposed upper and lower surfaces, the circular plate defining a periphery and having a central annular hub adapted for mounting on a rotating shaft of a hopper, the circular plate having a plurality of slots formed therein; and
a plurality of substantially L-shaped members depending from the lower surface at the periphery of the circular plate. the circular plate being adapted for mounting within the hopper and to be rotated near a bottom of the hopper, the circular plate being spaced apart from the bottom of the hopper by the plurality of substantially L-shaped members.

13. The feed plate as recited in claim 12, further comprising a pair of prongs projecting axially from the upper surface of the circular plate.

14. The feed plate as recited in claim 12, wherein the upper surface of the circular plate includes texturing thereon.

15. The feed plate as recited in claim 14, wherein the texturing comprises a radially extending groove formed in the upper surface of the circular plate.
